(19) United States
(12) Patent Application Publication
(10) Pub. No.: US 2012/0292000 A1
(43) Pub. Date: Nov. 22, 2012

(54) TURBULATORS FOR HEAT EXCHANGER TUBES

(75) Inventors: Tabraiz Ali Khan, Wichita, KS (US); Gregory Kenneth Reaser, Wichita, KS (US); Ronald Lee Griffith, Wichita, KS (US); Thomas Dale Chase, Derby, KS (US); George Nasrallah Tahan, Park City, KS (US)

(73) Assignee: Johnson Controls Technology Company, Holland, MI (US)

(21) Appl. No.: 13/451,425

(22) Filed: Apr. 19, 2012

Related U.S. Application Data
(60) Provisional application No. 61/486,580, filed on May 16, 2011.

(51) Int. Cl. F28F 13/12; B23P 15/26

(52) U.S. Cl. 165/109.1; 29/890.03

(57) ABSTRACT

The present disclosure is directed to heat transfer turbulators that can be disposed within heat exchanger tubes. The heat transfer turbulators are designed to promote turbulent flow of a heat transfer fluid through the heat exchanger tubes. The heat transfer turbulators include a helically shaped body portion that extends within the tubes and is constructed at least partially of plastic. The heat transfer turbulators also include an extension portion that extends outside of the tube from the body portion and has an outer diameter that is greater than the inner diameter of the tube.

### CROSS REFERENCE TO RELATED APPLICATIONS

This application claims priority from and the benefit of U.S. Provisional Application Ser. No. 61/486,580, entitled “TURBULATORS FOR HEAT EXCHANGER TUBES”, filed May 16, 2011, which is hereby incorporated by reference.

### BACKGROUND

The invention relates generally to turbulators that may be employed in heat exchanger tubes of heating, ventilating, and air conditioning (HVAC) systems.

A wide range of applications exists for heating, ventilating, and air conditioning (HVAC) systems. For example, residential, light commercial, commercial, and industrial systems are used to control temperatures and air quality in residences and buildings. HVAC units, such as air handlers, furnaces, heat pumps, and air conditioning units, are used to provide heated and/or cooled air to conditioned environments. Very generally, these systems operate by implementing a thermal cycle in which fluids are heated and cooled to provide the desired temperature in a controlled space, typically the inside of a residence or building. Similar systems are used for vehicle heating and cooling, as well as for general refrigeration.

Heat exchangers are generally employed within HVAC systems to transfer heat between a fluid flowing through the heat exchanger and another fluid that provides heating and/or cooling for the conditioned space. For example, in an air conditioning system or a heat pump system, a refrigerant can be circulated within a closed loop through a cycle of evaporation and condensation to heat and cool a fluid, such as air. As the refrigerant is evaporated in one heat exchanger, the refrigerant absorbs heat from air flowing through the heat exchanger to produce cooled air. As the refrigerant is condensed in another heat exchanger, the refrigerant transfers heat to the air to produce heated air. In another example, within a furnace, a fuel may be combusted to produce hot combustion gases. The hot combustion gases can be directed through one or more heat exchangers to heat air that flows across the heat exchangers.

Many types of heat exchangers include tubes that circulate a heat transfer fluid, such as refrigerant or hot combustion gases, through the heat exchanger. As the heat transfer fluid flows through the heat exchanger tubes, heat is transferred between the heat transfer fluid and the walls of the heat exchanger tubes. For example, when a heat exchanger provides heating, heat is transferred from the heat transfer fluid flowing through the heat exchanger tubes to the walls of the heat exchanger tubes. The heat is then transferred from the tube walls to an external fluid, such as air, flowing across the heat exchanger tubes to heat the external fluid. When a heat exchanger provides cooling, the direction of heat transfer is reversed. In particular, as an external fluid flows across the heat exchanger tubes, heat is transferred from the external fluid to the tube walls, thereby cooling the external fluid and heating the tube walls. The heat from the tube walls is then transferred to the heat transfer fluid flowing through the heat exchanger tubes. The efficiency of heat transfer for a heat exchanger can be affected by how well heat is transferred between the heat transfer fluid flowing through the heat exchanger tubes and the tube walls. Accordingly, it may be desirable to increase the contact between the heat transfer fluid and the tube walls, in order to promote increased heat transfer efficiency.

### SUMMARY

The present invention relates to a heat exchanger that includes a first end, a second end, and a plurality of tubes configured to direct a heat transfer fluid between the first end and the second end. The heat exchanger also includes a turbulator inserted within one or more of the plurality of tubes to swirl the heat transfer fluid within the tube. The turbulator includes a helically shaped body portion enclosed within the tube and constructed at least partly of plastic and an extension portion that extends beyond a length of the tube and has an outer diameter that is greater than an inner diameter of the tube.

The present invention also relates to a system that includes a burner configured to produce combustion gases, a first panel and a second panel configured to form a vestibule within a furnace, and a heat exchanger that includes a plurality of tubes extending between the first panel and the second panel to direct the combustion gases through the vestibule. The system also includes a turbulator inserted within one of the plurality of tubes to swirl the heat transfer fluid within the tube. The turbulator includes a helically shaped body portion enclosed within the tube and constructed at least partly of plastic and an extension portion that extends beyond a length of the tube and has an outer diameter that is greater than an inner diameter of the tube.

The present invention further relates to a method for assembling a heat exchanger. The method includes inserting a first end of a heat exchanger tube through an opening in a first panel. The method also includes inserting a first end of a turbulator, which includes a helically shaped body portion and an extension portion, into the heat exchanger tube until the body portion is entirely disposed within the heat exchanger tube and until the extension portion contacts a second end of the heat exchanger tube and extends beyond the second end of the heat transfer tube.

### DRAWINGS

FIG. 1 is an illustration of an embodiment of a residential HVAC&R system that employs heat exchangers.

FIG. 2 is a diagrammatical overview of an embodiment of a furnace that may be employed in the residential HVAC&R system of FIG. 1.

FIG. 3 is an exploded view of a portion of the furnace of FIG. 2, depicting heat transfer turbulators disposed within the secondary heat exchanger.

FIG. 4 is a side view of an embodiment of a heat transfer turbulator.

FIG. 5 is a cross-sectional view of a portion of a heat exchanger tube of FIG. 3 assembled within a furnace.

FIG. 6 is a perspective view of an embodiment of a heat transfer turbulator that includes an end cap.

FIG. 7 is a perspective view of an embodiment of heat transfer turbulators connected by a web.

FIG. 8 is a perspective view of another embodiment of heat transfer turbulators connected by a web.

FIG. 9 is a side view of an embodiment of a body portion of a heat transfer turbulator.

FIG. 10 is a side view of another embodiment of a body portion of a heat transfer turbulator.

FIG. 11 is a perspective view of an embodiment of a heat exchanger that may employ heat transfer turbulators.

### DETAILED DESCRIPTION

The present disclosure is directed to heat transfer turbulators that can be disposed within heat exchanger tubes. The heat transfer turbulators are designed to promote turbulent flow of a heat transfer fluid through the heat exchanger tubes. Further, the heat transfer turbulators may be designed to displace the heat transfer fluid flowing through the center of the heat exchanger tubes, thereby, causing the heat transfer fluid to flow in a more tortuous path through the heat exchanger tubes. Moreover, the heat transfer turbulators may be designed to increase the turbulence of the heat transfer fluid flowing through the heat exchanger tubes, which in turn may improve the heat transfer efficiency. According to certain embodiments, the heat transfer turbulators may be designed to promote contact between the heat transfer fluid and the tube walls, which in turn may increase the heat transfer efficiency of heat exchangers employing the heat transfer turbulators, as compared to heat exchangers without heat transfer turbulators. The heat transfer turbulators include a helically shaped body portion that extends within the tubes and is constructed at least partially of plastic. The at least partial plastic construction may allow more intricate helical shapes to be produced and may enable the heat transfer turbulators to be constructed with lower cost materials relative to heat transfer turbulators constructed using metal. The heat transfer turbulators also include an extension portion that extends outside of the tube from the body portion and has an outer diameter that is greater than the inner diameter of the tube. According to certain embodiments, the extension portion may facilitate manufacturing and/or assembly, and, in certain embodiments, may facilitate the use of automated assembly processes. Further, the extension portion of the turbulator may be designed to retain the turbulator in a desired location within the heat exchanger tube.

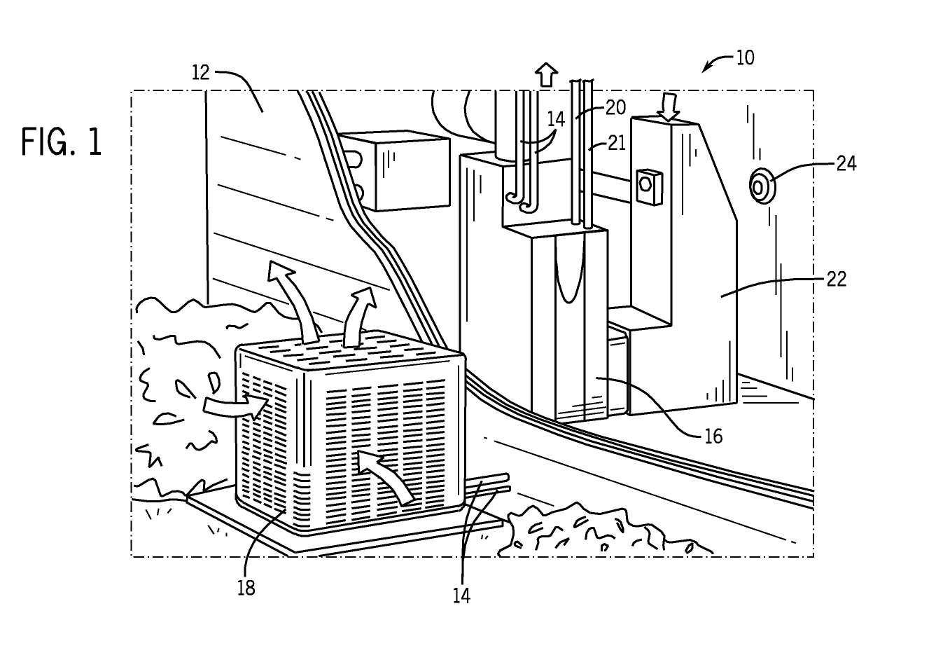

FIG. 1 depicts an exemplary application for heat exchangers that include heat transfer turbulators. In presently contemplated applications, the heat transfer turbulators may be used in heat exchangers employed in residential, commercial, light industrial, or industrial applications, and in any other application where heat exchangers are employed for heating or cooling a volume or enclosure, such as a residence, building, structure, and so forth. Specifically, the heat transfer turbulators are discussed in the context of a furnace in a residential HVAC system. Further, the heat transfer turbulators may be particularly well suited for use in secondary heat exchangers of condensing furnaces. However, in other embodiments, the heat transfer turbulators may be used in heat exchanger tubes in other types of suitable heat exchangers, such as heat exchangers employed in indoor and/or outdoor units of air conditioning systems, radiators, or chillers, among others.

FIG. 1 illustrates a residential heating and cooling system 10. In general, a residence 12 will include conduits 14 that transfer refrigerant between an indoor unit 16 to an outdoor unit 18. Indoor unit 16 may function as a furnace to provide heating, while outdoor unit 18 may be an air conditioning unit that provides cooling. According to certain embodiments, indoor unit 16 may be a high-efficiency condensing furnace that extracts heat from the combustion gases to condense the water vapor present in the combustion gases. Indoor unit 16 includes a combustion air pipe 20 that direct combustion air to the indoor unit 16, where the combustion air can be mixed with fuel and burned to generate heat, and an exhaust pipe 21 that directs exhaust gases out of the indoor unit 16. Indoor unit 16 can be positioned in a utility room, an attic, a basement, and so forth, while outdoor unit 18 can be situated adjacent to a side of residence 12. The heat transfer turbulators described herein may be employed in heat exchangers included within indoor unit 16 and/or outdoor unit 18.

When the system 10 is functioning in the cooling mode, conduits 14 transfer refrigerant between indoor unit 16 and outdoor unit 18, typically transferring primarily liquid refrigerant in one direction and primarily vaporized refrigerant in an opposite direction. For example, an evaporator within indoor unit 16 may absorb heat from air to evaporate the refrigerant flowing through the conduits 14 and provide cooled air that can be provided to residence 12. The evaporated refrigerant can then be directed through the conduits 14 to a condenser in the outdoor unit 18. Outdoor unit 18 draws in environmental air through its sides as indicated by the arrows directed to the sides of the unit, forces the air through the condenser by a means of a fan (not shown), and expels the air as indicated by the arrows above outdoor unit 18. As the air flows over heat exchanger tubes of the condenser, the air absorbs heat from the refrigerant to condense the refrigerant. The condensed refrigerant can then be returned to the evaporator within indoor unit 16 via conduits 14 to again absorb heat from the air. The cooled air can then be circulated through residence 12 by means of ductwork 22, as indicated by the arrows entering and exiting ductwork 22.

The overall system 10 operates to maintain a desired temperature as set by a thermostat 24. In the cooling mode, when the temperature sensed inside the residence is higher than the set point on the thermostat, the air conditioner will become operative to refrigerate additional air for circulation through the residence. When the temperature reaches the set point, the unit will stop the refrigeration cycle temporarily. Further, thermostat 24 can be employed to switch the system 10 between the cooling mode where the outdoor air conditioning unit 18 functions to provide cooling and the heating mode where the indoor furnace unit 16 functions to provide heating. In the heating mode, when the temperature sensed inside the residence is lower than the set point on the thermostat, the furnace will become operative to heat additional air for circulation through the residence. When the temperature reaches the set point, the unit will stop the heating operation temporarily.

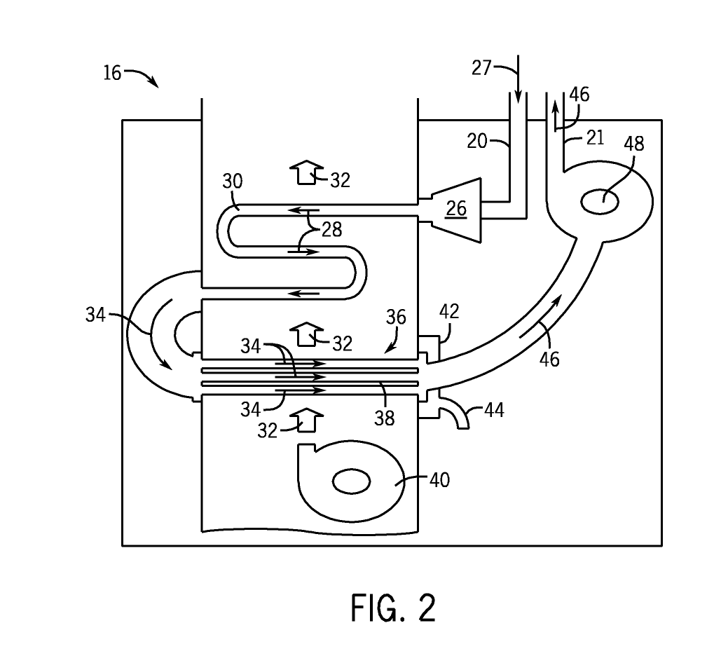

FIG. 2 is a schematic diagram of indoor unit 16. For clarity, the evaporator employed in the cooling mode is not shown. Indoor unit 16 includes a burner 26 that combusts a fuel with combustion air 27 that enters indoor unit 16 through combustion air pipe 20. Burner 26 produces hot combustion gases 28 that flow through a primary heat exchanger 30. According to certain embodiments, the temperature of the hot combustion gases 28 exiting burner 26 may be approximately 1300 to 2000 deg C., and all subranges therebetween. However, in other embodiments, the temperature of the hot combustion gases 28 may vary. The supply air 32 flows across primary heat exchanger 30, which transfers heat from the hot combustion gases 28 flowing through primary heat exchanger 30 to heat the supply air 32 and produce cooler combustion gases 34. According to certain embodiments, the temperature of the cooler combustion gases 34 may be approximately 290 to 410 deg C., and all subranges therebetween. However, in other embodiments, the temperature of the cooler combustion gases 34 may vary.

The cooler combustion gases 34 exiting primary heat exchanger 30 are then directed through a secondary heat exchanger 36. In particular, the cooler combustion gases 34 flow through tubes 38 of secondary heat exchanger 36. The supply air 32 flows across secondary heat exchanger 36, which transfers heat from the cooler combustion gases 34 flowing through tubes 38 to the supply air 32 to further heat the supply air 32. A blower 40, or similar air-moving device, directs the supply air 32 across secondary heat exchanger 36 and primary heat exchanger 30. The supply air 32 first flows across secondary heat exchanger 36 where supply air 32 is preheated by the cooler combustion gases 34 flowing through tubes 38 of secondary heat exchanger 36. The supply air 32 then flows across primary heat exchanger 30, where the supply air 32 is further heated by the hot combustion gases 28 flowing through primary heat exchanger 30. The heated supply air 32 can be directed through ductwork to heat a building, such as residence 12, shown in FIG. 1.

As the cooler combustion gases 34 flow through tubes 38 of secondary heat exchanger 36 and transfer heat to the supply air 32, a portion of the combustion gases may condense into a liquid. The condensed liquid is collected in a condensate pan 42 and can then be directed through a drain line 44 to exit indoor unit 16. The condensate formed in secondary heat exchanger 36 contains water, as well as combustion products and contaminants that can be acidic and/or corrosive. Accordingly, at least a portion of secondary heat exchanger 36 and condensate pan 42 may be constructed of corrosion resistant materials, such as stainless steel, corrosion resistant metal or alloys, or high temperature polymeric materials, among others.

The remaining combustion gases exit the indoor unit 16 as exhaust gases 46 that are drawn by an inducer 48 into exhaust pipe 21. According to certain embodiments, the exhaust gases 46 may have a temperature of approximately 35 to 95 deg C., and all subranges therebetween. However, in other embodiments, the temperature of the exhaust gases 46 may vary.

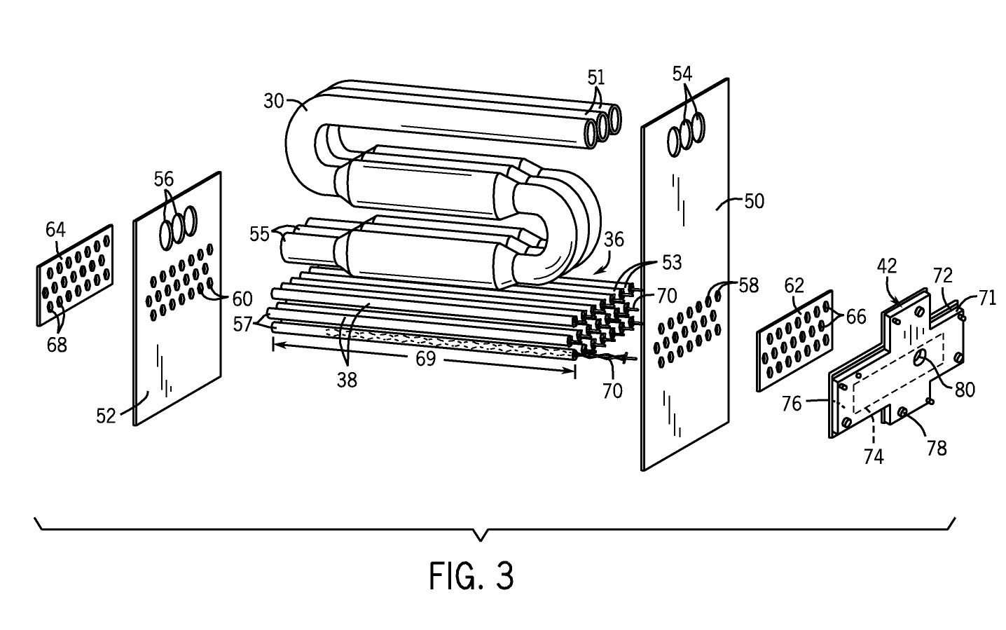

FIG. 3 is an exploded view of a portion of indoor unit 16. Panels 50 and 52 are disposed generally parallel to one another on opposite sides of heat exchangers 30 and 36 to form a vestibule. According to certain embodiments, panels 50 and 52 may be sheet metal panels constructed of aluminum or alloy steel. As shown in FIG. 2, blower 40 directs supply air 32 through the vestibule formed by panels 50 and 52. As the supply air 32 flows through the vestibule, the supply air 32 flows across heat exchangers 30 and 36, which transfer heat from combustion gases 28 and 34 to the supply air 32. Heat exchangers 30 and 36 extend through panels 50 and 52 to allow combustion gases 28 and 34 to enter and exit the vestibule formed by panels 50 and 52. For example, panel 50 includes openings 54, which receive tube ends 51 of primary heat exchanger 30, and openings 58, which receive tube ends 53 of secondary heat exchanger tubes 38. Panel 52 includes openings 56, which receive tube ends 55 of primary heat exchanger 30, and openings 60, which receive tube ends 57 of secondary heat exchanger tubes 38.

As the cooler combustion gases 34 flow through secondary heat exchanger tubes 38, a portion of the combustion gases may condense and form liquid condensate. The liquid condensate, which may contain corrosive materials, may exit heat exchanger tubes 38 through end 53. Accordingly, plates 62 and 64 that are constructed of corrosion resistant material may be coupled to panels 50 and 52 adjacent to openings 58 and 60 to impede contact between the liquid condensate and the panels. According to certain embodiments, plates 62 and 64 may be brazed, welded, adhesively bonded, or otherwise joined to panels 50 and 52. Further, in certain embodiments, plates 62 and 64 may be constructed of 29-4C stainless steel, grade 2205 stainless steel, or other corrosion resistant metal, alloy or polymeric material, among others.

Plates 62 and 64 include openings 66 and 68, respectively, which generally align with openings 58 and 60. Tube ends 57 extend through openings 60 and 68, while tube ends 53 extend through openings 58 and 66 and into condensate pan 42. Tubes 38 have a length 69 sufficient for tubes 38 to extend through panels 50 and 52, plates 62 and 64, and into condensate pan 42. According to certain embodiments, fins may be positioned between and/or around tubes 38 to promote heat transfer between tubes 38 and the supply air. In these embodiments, secondary heat exchanger 36 may be a fin and tube heat exchanger. However, in other embodiments, secondary heat exchanger 36 may be another type of heat exchanger, such as a shell and tube heat exchanger or a plate heat exchanger, among others.

Each tube 38 includes a heat transfer turbulator 70 that extends along the length 69 of the tubes 38. However, in other embodiments, only some of the tubes 38 may include heat transfer turbulators 70. Heat transfer turbulators 70 have a generally helical shape designed to swirl the combustion gases 34 flowing through the tubes 38. According to certain embodiments, heat transfer turbulators 70 may be designed to promote contact between the combustion gases 34 and the inner surfaces of tubes 38. Further, the heat transfer turbulators can be designed to displace the combustion gases 34 flowing through the center portion of tubes 38 to produce a more tortuous path for the combustion gases 34 to flow through tubes 38. According to certain embodiments, the tortuous path and/or swirled flow pattern provided by the heat transfer turbulators may provide increased heat transfer efficiency as compared to tubes without heat transfer turbulators. The increased heat transfer efficiency may allow the combustion gases 34 to reach a lower temperature more quickly, which in turn may produce more condensate and thereby increase the efficiency of the furnace. Heat transfer turbulators 70 can be inserted through the ends 53 of tubes 38 that are adjacent to condensate pan 42 so that a portion of the heat transfer turbulators 70 extends from the tube ends 53 into the condensate pan 42.

Condensate pan 42 includes a body 71 that extends outward from a back plate 72 to form a condensate collection area between the back plate 72 and the body 71. An opening 74 in back plate 72 is disposed over openings 66 of plate 62 to allow tubes 38 to extend through openings 66 and through opening 74 into condensate pan 42. Condensate pan 42 also includes a rear surface 76 of body 71. According to certain embodiments, heat transfer turbulators 70 may abut rear surface 76. Although not shown, the interior of condensate pan 42 may include baffles and/or traps to direct the flow of condensate within condensate pan 42 towards a drain connection 78. Condensate formed in tubes 38 may flow through tubes 38, into condensate pan 42, and through drain connection 78 where the condensate may be directed to a drain, sewer, or the like. The remaining combustion gases 34 may exit the tubes 38 as exhaust gas 46 that flows through condensate pan 42 to an aperture 80 connected to inducer 48 (FIG. 2), for example, by a conduit. As shown in FIG. 2, inducer 48 draws the exhaust gas 46 from condensate pan 42 through aperture 80 to exhaust pipe 21.

The portion of indoor unit 16 shown in FIG. 3 can be assembled using a manual process, an automated process, or a combination thereof. For example, according to certain embodiments, tubes ends 51, 53, 55, and 57 can be inserted through openings 54, 56, 58, and 60 of panels 50 and 52. Openings 66 and 68 of plates 62 and 64 can then be inserted over tube ends 53 and 57, and plates 62 and 64 can be attached to panels 50 and 52. Next, heat transfer turbulators 70 can be inserted into tube ends 53. Condensate pan 42 can then be attached to panel 50 to hold heat transfer turbulators 70 in place. However, in other embodiments, the order of assembly may vary. For example, in certain embodiments, heat transfer turbulators 70 may be inserted into tube ends 53 prior to insertion of tube ends 53 into openings 58.

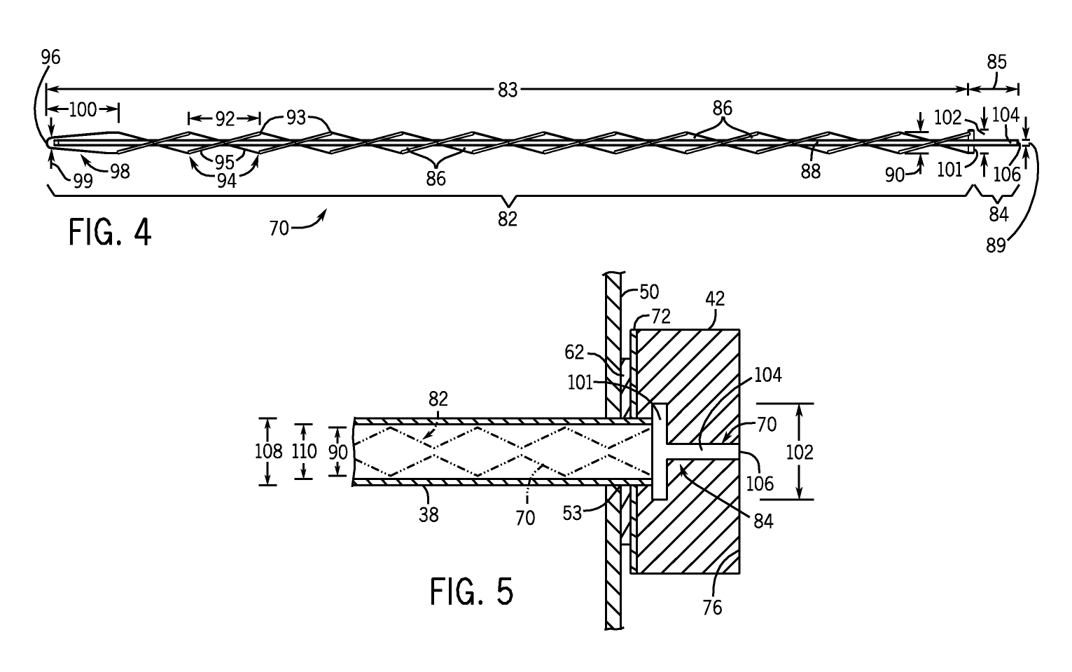

FIG. 4 depicts an embodiment of a heat transfer turbulator 70 that can be inserted in a tube 38, shown in FIG. 3. Heat transfer turbulator 70 includes a body portion 82 designed to fit within tube 38 and an extension portion 84 designed to extend from tube end 53 into condensate pan 42. When heat transfer turbulator 70 is inserted in a tube 38, body portion 82 is located within the tube 38, while extension portion 84 is located outside of the tube 38. According to certain embodiments, body portion 82 has a length 83 that is slightly shorter than the length 69 of tube 38, which allows body portion 82 to extend along substantially the entire length 69 of tube 38. However, in other embodiments, the length 83 may be somewhat smaller than the length 69 so that body portion 82 extends along only part of tube 38. For example, in other embodiments, the length 83 may be approximately 1 to 99 percent of the length 69, and all subranges therebetween, or more specifically, approximately 80 to 99 percent of the length 69, and all subranges therebetween. According to certain embodiments, the length 83 of body portion 82 may be approximately 0.05 to 1 inches (0.1 to 2.5 cm) shorter than the length 69 of tube 38. For example, the length 83 of body portion 82 may be approximately 19.5 inches (49.5 cm), while the length 69 may be approximately 19.7 to 20 inches (50.0 to 50.8 cm). However, in other embodiments, the relative lengths 69 and 83 of tube 38 and heat transfer turbulator 70 may vary depending on factors such as the type of heat exchanger, among others.

Extension portion 84 of heat transfer turbulator 70 extends from body portion 82 and has a length 85. According to certain embodiments, the length 85 of extension portion 84 may be approximately 0.75 to 1.25 inches (1.9 to 3.2 cm), and all subranges therebetween. More specifically, the length 85 may be approximately 1 inch (2.5 cm). In certain embodiments, the length 85 of extension portion 84 may be approximately 1 to 10 percent, or more specifically, approximately 5 percent, as long as the length 83 of body portion 82. However, in other embodiments, the length 85 of extension portion 84 may vary, depending on factors such as the depth of condensate pan 42, among others.

Body portion 82 includes wings 86 that extend radially outward from a backbone 88 in a spiral or helical pattern. According to certain embodiments, the backbone 88 may be a unitary piece that extends through both the body portion 82 and the extension portion 84. Further, in certain embodiments, the backbone 88 may have a rectangular, circular, elliptical, or triangular cross-sectional shape. Pairs of wings 86 are disposed across from one another on generally opposite sides of backbone 88, however, in other embodiments, the wings 86 may be staggered along the backbone 88. As shown, wings 86 have a generally triangular shape, however, in other embodiments, the shape of wings 86 may vary. For example, in other embodiments, wings 86 may have a square, circular, rectangular, or elliptical shape, among others. Backbone 88 has a thickness 89 sufficient to support wings 86, which extend outward from backbone 88. According to certain embodiments, the thickness 89 may be approximately 0.10 to 0.15 inches (0.25 to 0.38 cm), and all subranges therebetween. More specifically, the thickness 89 may be approximately 0.125 inches (0.32 cm). However, in other embodiments, the thickness 89 may vary.

Heat transfer turbulator 70 has a diameter 90 that is at least slightly smaller than an inner diameter of tube 38 to allow heat transfer turbulator 70 to be inserted into tube 38. For example, according to certain embodiments, the diameter 90 may be at least approximately 0.05 to 0.2 inches (0.13 to 0.51 cm), and all subranges therebetween, smaller than the inner diameter of tube 38. In another example, the diameter 90 may be at least approximately 1 to 20 percent smaller than the inner diameter of tube 38. In certain embodiments, the diameter 90 of heat transfer turbulator 70 may be approximately 0.45 inches (1.14 cm), while the inner diameter of tubes 38 may be approximately 0.50 inches (1.27 cm). However, in other embodiments, the relative diameters of the heat transfer turbulator 70 and the tube 38 may vary.

Wings 86 are separated from one another by a distance 92 that represents the distance between apexes 93 of adjacent wings. According to certain embodiments, the wings 86 may complete one half twist around the backbone 88 between adjacent wings. However, in other embodiments, the helical twist of the wings 86 around the backbone 88 may be tighter or looser. For example, in certain embodiments, the wings 86 may twist helically by approximately 90 to 360 degrees over the distance 92, and all subranges therebetween. According to certain embodiments, the distance 92 may be approximately 0.75 to 1.75 inches (1.9 to 4.5 cm), and all subranges therebetween, or more specifically, approximately 1.5 inches (3.8 cm). However, in other embodiments, the distance 92 may vary.

Wings 86 have angled sides 95 that twist radially around the backbone 88. The angled sides 95 of longitudinally adjacent wings may be separated by a pitch angle 94. The pitch angle 94 generally represents the angle formed between longitudinally adjacent angles sides 95 where the angled sides 95 intersect the backbone 88. According to certain embodiments, the pitch angle 94 may be approximately 90 to 180 degrees, and all subranges therebetween, or more specifically, approximately 150 degrees. However, in other embodiments, the pitch angle 94 may vary.

Heat transfer turbulator 70 includes an end 96 with a tapered portion 98 that facilitates insertion into a tube end 53. According to certain embodiments, tapered portion 98 may guide heat transfer turbulator 70 into a tube 38. Tapered portion 98 has a length 100, over which the tapered portion 98 narrows from the outer diameter 90 of the heat transfer turbulator 70 to a diameter 99. Tapered portion 98 has a relatively flat shape and does not twist helically around backbone 88. However, in other embodiments, tapered portion may twist around backbone 88 and/or have a differently shaped cross-section. According to certain embodiments, the length 100 of tapered portion 98 may be approximately 1.4 to 1.6 inches (4.1 cm), and all subranges therebetween, or more specifically, approximately 1.5 inches (3.8 cm). However, in other embodiments, the length 100 may vary, based on factors such as the length 83 of the body portion 82 or the length 69 of the tubes, among others. Moreover, in certain embodiments, the length 100 may be approximately 1 to 15 percent of the length 83 of body portion 82, and all subranges therebetween. The diameter 99 of the tapered portion 98 may be slightly greater than the thickness 89 of the backbone 88. According to certain embodiments, the diameter 99 may be approximately 10 to ′l percent as large as the diameter 90.

When end 96 and body portion 82 are inserted within a tube 38, extension portion 84 extends from an end 53 of tube 38. Extension portion 84 includes a crosspiece 101 disposed generally perpendicular to backbone 88. Crosspiece 101 abuts end 53 of tube 38 and extends perpendicular to backbone 88 to produce an outer diameter 102 of the extension portion 42. The outer diameter 102 of the extension portion 84 is at least slightly greater than the inner diameter of tube 38 to impede extension portion 84 from entering tube 38. According to certain embodiments, the outer diameter 102 may be approximately 1 to 10 percent greater than the inner diameter of tube 38, and all subranges therebetween. For example, according to certain embodiments, outer diameter 102 may be approximately 0.52 inches (1.32 cm), while the tube inner diameter may be approximately 0.5 inches (1.27 cm).

Extension portion 84 also includes a spacer portion 104 with an end 106. According to certain embodiments, spacer portion 104 may be an integral part of the backbone 88. In these embodiments, backbone 88 may extend through crosspiece 101, and the portion of the backbone on the opposite side of crosspiece 101 from body portion 82 may function as spacer portion 104. However, in other embodiments, spacer portion 104 may be a separate piece coupled to crosspiece 101. Spacer portion 104 is disposed generally perpendicular to crosspiece 101 and extends outward from crosspiece 101 away from the body portion 82. Together, crosspiece 101 and spacer portion 104 form a T-shaped extension portion 84. However, in other embodiments, crosspiece 101 and spacer portion 104 may be disposed at various angles relative to one another to form an extension portion 84 of another shape. Further, in certain embodiments, multiple cross pieces 101 and/or spacer portions 104 may be included in extension portion 84. As discussed further below with respect to FIG. 5, when heat transfer turbulator 70 is inserted within a tube 38, spacer portion 104 extends into condensate pan 42 so that end 106 abuts the rear surface 76 of condensate pan 42. Accordingly, condensate pan 42 may interface with spacer portion 104 to impede heat transfer turbulator 70 from exiting tube 38 through end 53 (FIG. 1).

Heat transfer turbulator 70 is constructed at least partially of a polymeric material, such as plastic. According to certain embodiments, the polymeric material may include a polyphenylene sulfide based polymer, a polyimide based polymer, a glass filled plastic, a thermoset polymer, or other moldable plastics, or a combination thereof. Moreover, in certain embodiments, the polymeric material may be a high temperature polymer designed to withstand the high temperatures produced by the combustion gases flowing through the tubes 38. According to certain embodiments, the polymeric material may be designed to withstand temperatures of at least 290 to 410 deg C., and all subranges therebetween. In certain embodiments, the polymeric material may include Ryton®, commercially available from Chevron Phillips Chemical Company LP of The Woodlands, Tex.; Fortron®, commercially available from Ticona of Florence, Ky.; or Duratron®, commercially from Quadrant, of Reading, Pa. The use of a polymeric material may facilitate manufacturing and reduce costs, when compared to the use of metal materials. For example, the polymeric material may be more easily molded into complex geometries that can be used in heat transfer turbulator 70, when compared to a metal forming process. Accordingly, the polymeric material may be employed to achieve the desired shape, pitch, and/or twist of wings 86.

According to certain embodiments, heat transfer turbulator 70 is constructed entirely of a polymeric material, such as a plastic. In these embodiments, heat transfer turbulator 70 may be a unitary plastic piece formed by a process such as injection molding, among others. In certain embodiments, heat transfer turbulator 70 may be constructed of a single type of material. However, in other embodiments, two or more different materials, such as different types of polymeric materials or a combination of a polymeric material and a metal, may be employed within heat transfer turbulator 70. For example, in certain embodiments, body portion 82 may be constructed of one material, while extension portion 84 is constructed of another material. In another example, the part of body portion 82 that is closest to end 96 may be constructed of one material, while the rest of heat transfer turbulator 70 is constructed of one or more other materials. For example, the first 1 to 80 percent of length 83, and all subranges therebetween, disposed adjacent to end 96 may be constructed of one material, while the rest of heat transfer turbulator 70 is constructed of one or more other materials. Furthermore, according to certain embodiments, some parts of heat transfer turbulator 70 (e.g., backbone 88, extension portion 84, tapered portion 98) may be constructed with a metal, while other parts may be constructed with a polymeric material (e.g., wings 86, extension portion 84, tapered portion 98).

As described above with respect to FIG. 2, heat transfer turbulators 70 may be employed in tubes 38 of heat exchangers used in a relatively high temperature environment, such as a furnace. When a heat transfer turbulator 70 is inserted in a furnace heat exchanger tube, the portion of heat transfer turbulator disposed adjacent to end 96 may experience higher temperatures than the rest of heat transfer turbulator 70 since the combustion gases 34 first contact end 96 as the combustion gases 34 flow through tube 38 and transfer heat to supply air 32 (FIG. 1). Accordingly, the portion of heat transfer turbulator 70 that is adjacent to end 96 may be constructed of a high temperature polymeric material or may be constructed of a metal, while the rest of heat transfer turbulator 70 is constructed of one or more relatively lower temperature polymeric materials. Further, in other embodiments, the entire heat transfer turbulator 70 may be constructed of one or more high temperature polymeric materials.

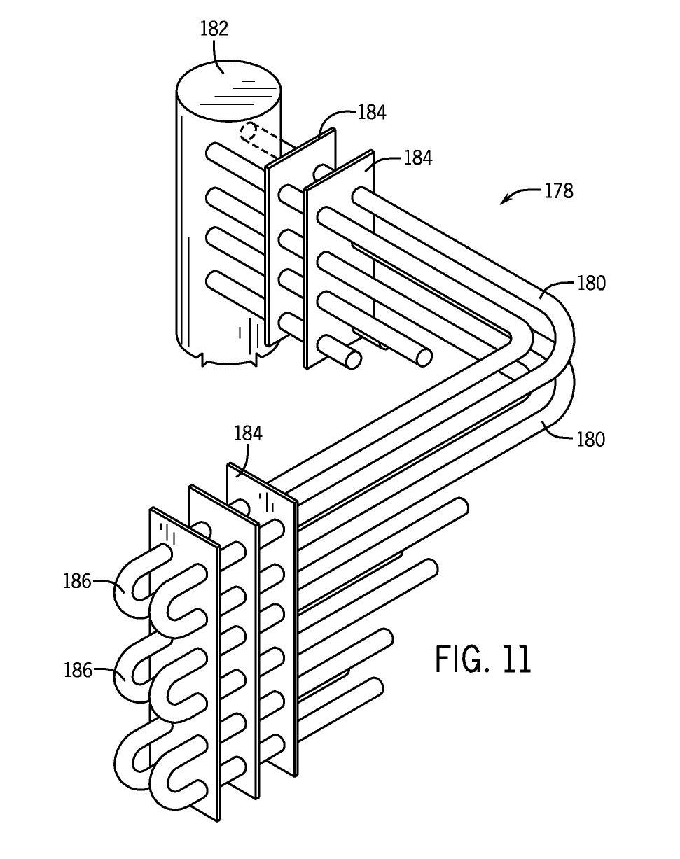

As described further below with respect to FIG. 11, the heat transfer turbulators 70 described herein also may be employed in heat exchanger tubes used in lower temperature embodiments, such as residential air conditioners and heat pumps, among others. In these embodiments, the heat transfer turbulators 70 may be constructed of one or more relatively lower temperature materials, such as nylon, polycarbonate, and polypropylene, among others.

FIG. 5 is a cross-sectional view of a portion of a heat exchanger tube 38 of FIG. 3 assembled within a furnace. As assembled, condensate pan 42 abuts corrosion resistant panel 62, which abuts vestibule panel 50. End 53 of tube 38 extends through opening 58 (FIG. 3) in panel 50, opening 66 in plate 62, and opening 74 in back plate 72 of condensate pan 42 so that end 53 of tube 38 is disposed inside condensate pan 42. Further, tube 38 extends generally orthogonal to panel 50, panel 62, and back plate 72 of condensate pan 42. Tube 38 has an outer diameter 108 that is approximately equal to or slightly smaller than the diameter of openings 58 and 66 to enable tube 38 to extend through openings 58 and 66. Heat transfer turbulator 70 is inserted within tube 38 so that body portion 82 is enclosed by tube 38 and extension portion extends from end 53 of tube 38. The diameter 90 of heat transfer turbulator 70 is at least slightly smaller than the inner diameter 110 of tube 38 to enable heat transfer turbulator 70 to be inserted into tube 38. For example, according to certain embodiments, the diameter 90 of heat transfer turbulator 70 may be approximately 1 to 20 percent smaller than the inner diameter 110 of tube 38.

Heat transfer turbulator 70 is disposed in tube 38 so that crosspiece 101 abuts tube end 53. In particular, crosspiece 101 is disposed generally perpendicular to tube 38 so that crosspiece 101 extends past an inner diameter 110 of tube 38 to define the outer diameter 102 of extension portion 84. The outer diameter 102 is at least slightly greater than an inner diameter 110 of tube 38 to impede extension portion 84 from entering tube 38. As shown, the outer diameter 102 of extension portion 84 is also greater than the outer diameter 108 of tube 38. However, in other embodiments, the outer diameter 102 of extension portion 84 may be approximately equal to or slightly less than the outer diameter 108 of tube 38. For example, according to certain embodiments, the outer diameter 102 of extension portion 84 may be approximately 1 to 30 percent greater than the inner diameter 110 of tube 38, and all subranges therebetween.

Extension portion 84 of heat transfer turbulator 70 is disposed entirely within condensate pan 42. The spacer portion 104 of extension portion 84 extends toward rear surface 76 of condensate pan 42 and is disposed generally perpendicular to crosspiece 101, back plate 72, and rear surface 76. Spacer portion 104 is disposed on an opposite side of crosspiece 101 from backbone 88 and includes an end 106 that abuts rear surface 76 of condensate pan 42 to inhibit lateral movement of heat transfer turbulator 70 within tube 38. In other embodiments, a small gap may exist between rear surface 76 and end 106, which may allow heat transfer turbulator 70 to slide laterally within tube 38 for a small distance. Regardless of whether end 106 abuts rear surface 76 or is disposed slightly away from rear surface 76, rear surface 76 of condensate pan 42 functions to retain heat transfer turbulator 70 within tube 38.

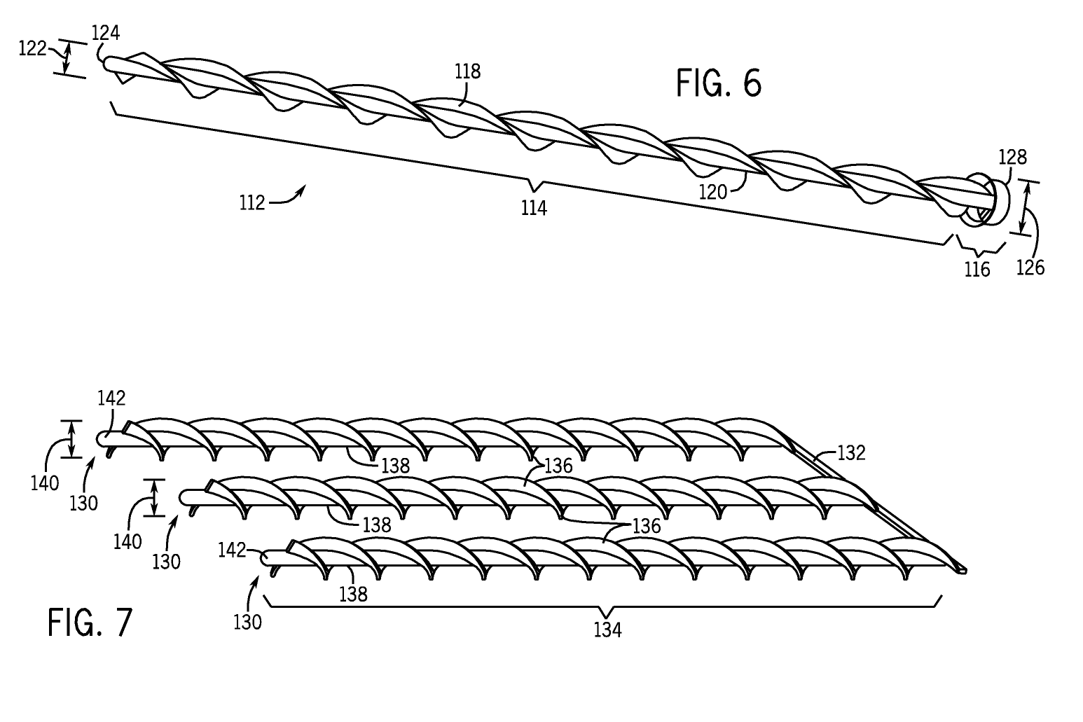

FIGS. 6 through 10 describe other embodiments of heat transfer turbulators that may inserted in tubes 38 of FIG. 3. According to certain embodiments, the heat transfer turbulators shown in FIGS. 6 through 10 can be manufactured by injecting a molten polymer into a mold (i.e., injection molding), or using any other manufacturing technique (e.g., extrusion molding, etc.). Further, the heat transfer turbulators are constructed at least partially of polymeric material, such as polypropylene, polycarbonate, nylon, polyphenylene sulfide, glass filled plastics, or other suitable plastics. In certain embodiments, the heat transfer turbulators may be constructed entirely of one or more polymeric materials. However, in other embodiments, at least a portion of the heat transfer turbulators may be constructed of a metal, such as stainless steel, nickel, or another metal or alloy.

FIG. 6 depicts an embodiment of a heat transfer turbulator 112 that includes a body portion 114 and a cap style extension portion 116. Body portion 114 is designed to fit within a tube 38 and extension portion 116 is designed to extend from a tube end 53 into condensate pan 42. Body portion 114 includes a spiral section 118 that spirals radially outward from a backbone 120. Spiral section 118 may be designed to swirl the flow of combustion gases 34 within a tube 38 and direct the combustion gases 34 radially outward from backbone 120 towards the interior walls of tube 38. Spiral section 118 has a diameter 120 that is slightly smaller than the inner diameter 110 of a tube 38 to allow body portion 114 to be inserted into a tube 38. Body portion 114 also includes an end 124 designed to be inserted into a tube end 53. Spiral section 118 generally tapers toward end 124 to facilitate insertion into a tube 38.

Extension portion 116 is disposed generally perpendicular to backbone 120 and generally encircles backbone 120. According to certain embodiments, extension portion 116 may be a cap that is snapped onto, screwed onto, or interference fit onto backbone 120. However, in other embodiments, extension portion 116 may be integrally formed with backbone 120. Extension portion 116 has a diameter 126 that is at least slightly greater than the inner diameter 110 of tube 38 to impede extension portion 116 from entering tube 38. When heat transfer turbulator 112 is inserted within a tube 38, extension portion 116 may abut tube end 53. Extension portion 116 also includes an end 128 that is disposed on an opposite side of heat transfer turbulator 112 from end 124. When heat transfer turbulator 112 is inserted within a tube 38, end 124 may abut rear surface 76 of condensate pan 42 (FIG. 3). However, in other embodiments, end 124 may be spaced from rear surface 76 of condensate pan 42 to allow lateral movement of heat transfer turbulator 112 within a tube 38.

FIG. 7 depicts an embodiment of heat transfer turbulators 130 that are connected by a web 132. As shown, three heat transfer turbulators 130 extend generally parallel to one another from web 132. However, in other embodiments, any number of heat transfer turbulators may extend from a web. For example, 2, 3, 4, 5, 6, or more turbulators 130 may extend from web 132. According to certain embodiments, web 132 may facilitate the insertion of the heat transfer turbulators 130 that are connected by web 132 into tubes 38. For example, the web 132 and corresponding heat transfer turbulators 130 may be aligned with a set of tubes 138 and then inserted into the tubes 38 as a group using a manual and/or automated process.

Heat transfer turbulators 130 each include a body portion 134 designed to fit within tubes 38 while web 132 is designed to extend from tube ends 53. Upon insertion into tubes 38, web 132 is disposed generally perpendicular to tube ends 53 to inhibit the heat transfer turbulators 130 from moving farther into tubes 38. Body portion 134 includes a spiral section 136 that extends radially outward from a backbone 138 in a spiral or helical shape. Spiral section 136 may be designed to swirl the flow of combustion gases 34 within a tube 38 and direct the combustion gases 34 radially outward from backbone 138 towards the interior walls of tube 38. Spiral section 136 has a diameter 140 that is slightly smaller than the inner diameter 110 of a tube 38 to allow body portion 134 to be inserted into a tube 38. Body portion 134 also includes an end 142 designed to be inserted into a tube end 53. Spiral section 136 generally tapers toward end 142 to facilitate insertion into a tube 38.

According to certain embodiments, when ends 142 and body portions 134 are inserted within tubes 38, web 132 may be disposed within condensate pan 42 to abut rear surface 76 of condensate pan 42. However, in other embodiments, webs 132 may be spaced from rear surface 76. Further, in certain embodiments, a separate spacer may be coupled to web 132 and the spacer may abut rear surface 76 of condensate pan 42.

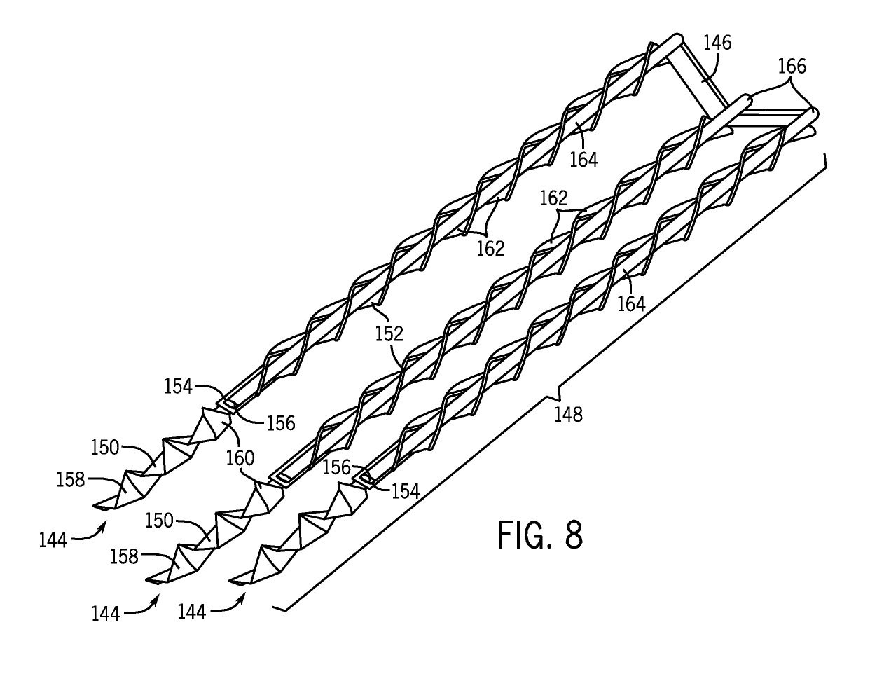

FIG. 8 depicts another embodiment of heat transfer turbulators 144 that are connected by a web 146. Web 146 extends generally orthogonal to each heat transfer turbulator 144. Similar to the web 132 discussed above with respect to FIG. 7, web 146 may facilitate the insertion of the heat transfer turbulators 144 that are connected by web 146 into tubes 38. However, rather than connecting heat transfer turbulators 130 that are connected in a generally straight line, as shown in FIG. 7, web 146 connects heat transfer turbulators 144 that are offset from one another with respect to a transverse axis of the heat transfer turbulators 144. For example, web 146 is constructed to extend in generally a straight line between only two adjacent heat transfer turbulators 144, thereby creating a zigzag shape. Such a zigzag shaped web 146 may allow the heat transfer turbulators 144 to be inserted into tubes 38 that are offset from one another within a heat exchanger.

Heat transfer turbulators 144 each include a body portion 148 designed to fit within tubes 38 while web 146 is designed to extend from tube ends 53. Upon insertion into tubes 38, web 146 is disposed generally perpendicular to tube ends 53 to inhibit the heat transfer turbulators 144 from moving farther into tubes 38. Each body portion 148 includes a higher temperature portion 150 and a lower temperature portion 152. Higher temperature portions 150 are disposed on ends 158 of heat transfer turbulators 144 that are opposite from web 146, while lower temperature portions 152 are disposed adjacent to web 146. When heat transfer turbulators 144 are inserted in a furnace heat exchanger tube, the higher temperature portions 150 of heat transfer turbulators 144 may experience higher temperature than the rest of heat transfer turbulators 144 since the combustion gases 34 first contact ends 158 as the combustion gases 34 flow through tubes 38 and transfer heat to supply air 32 (FIG. 1). Accordingly, higher temperature portions 150 may be constructed of a high temperature polymeric material, such as a polyphenylene sulfide based polymer, a polyimide based polymer, or a glass filled plastic, among others, while lower temperature portions 152 may be constructed of a lower temperature polymer, such as nylon, polycarbonate, or polypropylene, among others. Further, in certain embodiments, higher temperature portions 150 may be constructed of a metal, such as stainless steel. According to certain embodiments, higher temperature portions 150 may be constructed of a material designed to withstand temperatures of at least approximately 290 to 410 deg C., and all subranges therebetween, while lower temperature portions 152 may be constructed of a material designed to withstand temperatures of at least approximately 35 to 95 deg C., and all subranges therebetween. However, in other embodiments, the temperatures that the higher temperature portions 150 and the lower temperature portions 152 are designed to withstand may vary depending on factors such as the application of the heat exchanger and/or the fluid flowing through the tubes, among others.

Lower temperature portions 152 are coupled to web 146, and in certain embodiments, may be integrally formed with web 146. Lower temperature portions 152 each include a slot 154 designed to receive a tab 156 disposed on a respective higher temperature portion 150. According to certain embodiments, tabs 156 of higher temperature portions 150 may be inserted into slots 154 of lower temperature portions 152 to secure the higher temperature portions 150 to the lower temperature portions 152. However, in other embodiments, the higher temperature portions 150 may be joined to the lower temperature portions 152 by another joining method, such as staking Further, in other embodiments, rather than including only two portions 150 and 152, the heat transfer turbulators 144 may include three or more portions joined together to form body portions 148. For example, in a body portion 148 with three sections, a section closest to an end 158 may be constructed using metal, a middle section may be constructed using a high temperature polymer, and a section closest to ends 166 may be constructed using a lower temperature polymer.

Higher temperature portions 150 include wings 160 that extend radially outward in a spiral or helical pattern. As shown, wings 160 have a generally triangular shape, however, in other embodiments, the shape may vary. Lower temperature portions 152 include wings 162 that extend radially outward from a backbone 164 in a spiral or helical pattern. As shown, wings 162 have a generally triangular shape, however, in other embodiments, the shape may vary. For example, in other embodiments, wings 160 and 162 may have a square, triangular, rectangular, or elliptical shape, among others. Backbones 164 may extend through web 146 to form ends 166 that extend past web 146 to abut a rear surface 76 of condensate pan 42, when heat transfer turbulators 144 are inserted in furnace heat exchanger tubes. However, in other embodiments, ends 166 may be omitted.

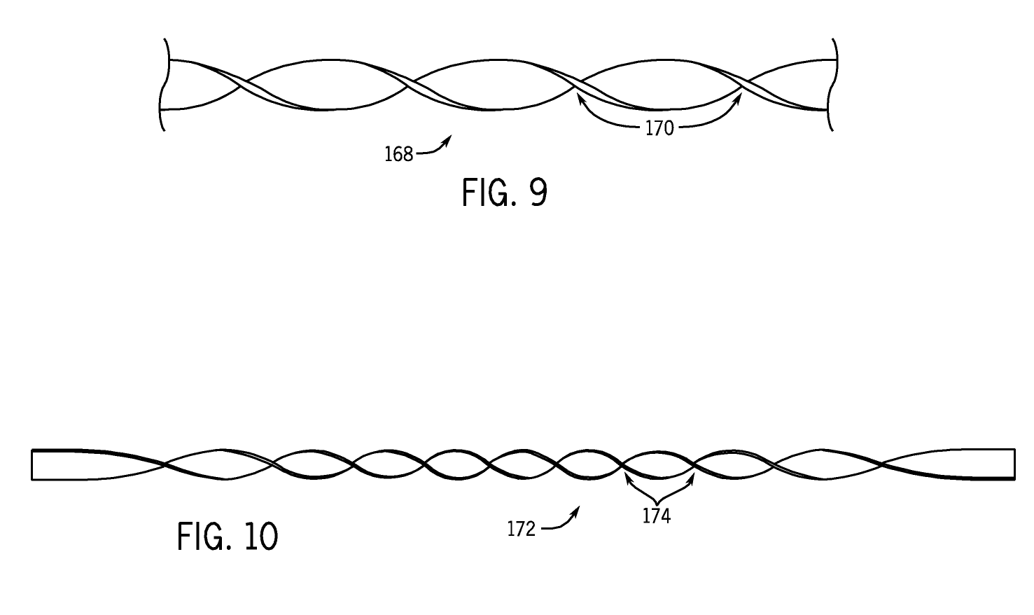

FIGS. 9 and 10 depict heat transfer turbulators 168 and 172 with other embodiments of body portions that can be inserted into a tube 38. Rather than employing backbones, the heat transfer turbulators 168 and 172 include spirals 170 and 174, respectively, that twist about themselves. Each spiral 170 and 174 has a similar twist to an adjacent spiral 170 and 174, producing a generally uniform twist among the spirals 170. Spiral 174 is a tighter spiral than spiral 170. In other embodiments, tighter or looser spirals may be employed in heat transfer turbulators. In certain embodiments, spirals 170 and 174 may be coupled to extension portions, such as extension portion 84 described with respect to FIG. 4, extension portion 116 described above with respect to FIG. 6, web 132 described above with respect to FIG. 7, or web 146 described above with respect to FIG. 8. According to certain embodiments, heat transfer turbulator 168 and 172 may be constructed of a single material, such as a polymeric material. However, in other embodiments, heat transfer turbulators 168 and 170 may be constructed using multiple materials, such as a high temperature polymer and a low temperature polymer, a metal and a polymer, or any combination thereof.

FIG. 11 illustrates another type of heat exchanger 178 that may employ the heat transfer turbulators described above with respect to FIGS. 4 to 10. According to certain embodiments, heat exchanger 178 may be employed in outdoor unit 18, shown in FIG. 1. Heat exchanger 178 includes tubes 180, in which heat transfer turbulators may be disposed. Tubes 180 are fluidly connected to a header 182 to circulate a fluid, such as refrigerant, through heat exchanger 178. Tubes 180 extend through fins 184, which are designed to promote heat transfer between an external fluid flowing across tubes 180 and an internal fluid flowing within tubes 180. Although plate fins 184 are shown in FIG. 11, in other embodiments, other types of fins, such as corrugated fins, may be employed. Tubes 180 further include a bent section 186 that allows the internal fluid to flow back to header 182. In certain embodiments, bent section 186 may be a separate structure, brazed or otherwise joined to tubes 180. Further, in certain embodiments, header 182 may be eliminated and a distributor may be used to provide refrigerant to the tubes 38. Moreover, in yet other embodiments, bent sections 186 may be replaced by a second header that directs refrigerant back to the first header 182.

The heat transfer turbulators described above with respect to FIGS. 4 to 10 can be employed in tubes 180 to promote contact between the internal fluid and the inner surfaces of tubes 180. For example, heat transfer turbulators may be inserted into tubes 180 to swirl the internal fluid flowing through tubes 180. In certain embodiments, the body portion of a heat transfer turbulator may be disposed in a tube 180 downstream or upstream of bent section 186. However, in other embodiments, the body portion of a heat transfer turbulator may include a flexible section that bends when inserted through bent section 186, allowing the heat transfer turbulator to extend through tube 180 and through bent section 186. The extension portion of a heat transfer turbulator may extends into header 182, and in certain embodiments, may interface with a rear wall of header 182 or with a plate disposed in header 182.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, etc.), mounting arrangements, use of materials, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A heat exchanger, comprising:
a first end;
a second end;
a plurality of tubes configured to direct a heat transfer fluid between the first end and the second end; and
a turbulator inserted within one or more of the plurality of tubes to swirl the heat transfer fluid within the tube, wherein the turbulator comprises a helically shaped body portion enclosed within the tube and constructed at least partly of plastic and an extension portion that extends beyond a length of the tube and has an outer diameter that is greater than an inner diameter of the tube.

2. The heat exchanger of claim 1, wherein the first end and the second end comprise panels configured to form a vestibule within a furnace.

3. The heat exchanger of claim 1, wherein the body portion of the turbulator comprises a central backbone extending along a length of the body portion and a plurality of wings extending helically outward from the central backbone.

4. The heat exchanger of claim 1, wherein the body portion of the turbulator comprises a tapered portion at an end of the turbulator opposite of the extension portion of the turbulator.

5. The heat exchanger of claim 1, wherein the body portion of the turbulator is constructed entirely of plastic.

6. The heat exchanger of claim 1, wherein the body portion of the turbulator comprises a metal portion disposed at an end of the turbulator opposite of the extension portion of the turbulator.

7. The heat exchanger of claim 1, wherein the extension portion of the turbulator and the body portion of the turbulator comprise a unitary molded plastic piece.

8. The heat exchanger of claim 1, wherein the extension portion of the turbulator is T-shaped.

9. The heat exchanger of claim 1, wherein the extension portion of the turbulator comprises a cap affixed to the body portion of the turbulator.

10. A system comprising:
a burner configured to produce combustion gases;
a first panel and a second panel configured to form a vestibule within a furnace;
a heat exchanger comprising a plurality of tubes extending between the first panel and the second panel to direct the combustion gases through the vestibule; and
a turbulator inserted within one of the plurality of tubes to swirl the heat transfer fluid within the tube, wherein the turbulator comprises a helically shaped body portion enclosed within the tube and constructed at least partly of plastic and an extension portion that extends beyond a length of the tube and has an outer diameter that is greater than an inner diameter of the tube.

11. The system of claim 10, comprising a condensate pan that contacts the extension portion of the turbulator.

12. The system of claim 10, comprising a first plate coupled to the first panel and a second plate coupled to the second panel, wherein the first and second plates are configured to inhibit corrosion.

13. The system of claim 10, comprising a plurality of turbulators connected by a web, wherein each of the turbulators comprises a body portion enclosed within the tube and constructed at least partly of plastic and an extension portion that extends beyond a length of the tube and has an outer diameter that is greater than an inner diameter of the tube, the web comprising a link connecting the extension portion of each of the turbulators.

14. The system of claim 10, comprising a blower configured to direct supply air through the vestibule to receive heat from combustion gases.

15. The system of claim 10, comprising a second heat exchanger configured to receive combustion gases prior to the heat exchanger receiving combustion gases.

16. The system of claim 10, wherein the body portion comprises a central backbone extending along a length of the body portion and a plurality of wings extending helically outward from the central backbone.

17. A method for assembling a heat exchanger, the method comprising:
inserting a first end of a heat exchanger tube through an opening in a first panel; and
inserting a first end of a turbulator, comprising a helically shaped body portion and an extension portion, into the heat exchanger tube until the body portion is entirely disposed within the heat exchanger tube and until the extension portion contacts a second end of the heat exchanger tube and extends beyond the second end of the heat transfer tube.

18. The method of claim 17, wherein the body portion is constructed at least partly of plastic.

19. The method of claim 17, wherein inserting a first end of a helical turbulator into the heat exchanger tube comprises inserting a tapered end of the turbulator into the heat exchanger tube.

20. The method of claim 17, comprising coupling a condensate pan to the first panel.
